(19) United States
(12) Patent Application Publication
(10) Pub. No.: US 2003/0114971 A1
(43) Pub. Date: Jun. 19, 2003

(54) Vehicle occupant restraint deployment control with lateral velocity responsive upgrade

(76) Inventors: Christopher Michael Caruso, Kokomo, IN (US); David L. Nelson, Kokomo, IN (US); Russell L. Simpson, Noblesville, IN (US); Brian Scott Kvapil, Janesville, WI (US); Timothy Michael O'Malley, Carmel, IN (US); Mary Jane Olsavsky, Cicero, IN (US)

Correspondence Address: ROBERT M. SIGLER, DELPHI TECHNOLOGIES, INC., Legal Staff, Mail Code: 480-414-420, P.O. Box 5052, Troy, MI, 48007-5052, US

(21) Appl. No.: 10/022,183

(22) Filed: Dec. 14, 2001

(51) Int. Cl. B60R 21/32

(52) U.S. Cl. 701/45; 280/735; 180/271

(57) ABSTRACT

A vehicle occupant restraint deployment control for a multi-stage restraint senses a longitudinal acceleration of a vehicle passenger compartment and generates a first stage deployment signal in response to a predetermined value of a longitudinal velocity derived from the longitudinal acceleration. The control is further responsive to a sensed lateral acceleration of the vehicle passenger compartment to generate a second stage deployment signal, provided that the first stage deployment signal has also been generated.

### TECHNICAL FIELD

The technical field of this invention is the control of vehicle occupant restraint deployment.

### BACKGROUND OF THE INVENTION

It is known that a vehicle occupant restraint deployment control may provide different levels of restraint deployment based on crash severity. For example, a first stage deployment may be commanded if a velocity derived from a vehicle passenger compartment located accelerometer exceeds a threshold value within a predetermined time period after the beginning of a detected possible crash event; but a second stage deployment, providing a greater level of protection in a more severe crash, is commanded if an additional criterion signifying a more severe crash is detected. Such an additional criterion may be, for example, a predetermined magnitude of the time rate of change of longitudinal acceleration (“jerk”) or predetermined magnitudes of “oscillation” and longitudinal velocity as described in copending patent application U.S. Ser. No. 09/690,141 Dual Stage Occupant Restraint Control Method for Motor Vehicle, filed Oct. 16, 2000 and assigned to the assignee of this application. Such criteria are derived from the sensed longitudinal acceleration of the vehicle passenger compartment.

But vehicle crashes are not always directly frontal; many crashes are angle crashes in which the acceleration produced by the crash has a significant lateral component. In such crashes, the total energy of the crash will generally be greater than would be indicated by a purely longitudinal acceleration sensor. Although some prior art crash controls are described as using a lateral motion sensor to supplement a deploy/no deploy decision; the methods described generally involve mathematically intensive vector calculations to determine a value used in a primary deployment decision.

### SUMMARY OF THE INVENTION

A vehicle occupant restraint control senses a longitudinal acceleration of a vehicle passenger compartment and processes the longitudinal acceleration to provide a first stage deployment function signal, for example a longitudinal velocity signal. Generation of a first stage deployment signal is based on a predetermined criterion of the first stage deployment function signal, for example the longitudinal velocity exceeding a boundary curve. The control further senses a lateral acceleration of the vehicle passenger compartment and generates a second stage deployment signal based on a predetermined criterion of the sensed lateral acceleration, for example the lateral acceleration exceeding a boundary curve, and further based on generation of the first stage deployment signal. A first stage deployment is dependent on generation of the first stage deployment signal; and a second stage deployment is dependent on generation of the second stage deployment signal.

Thus, a crash event which would be determined to require a first stage deployment on the basis of a monitored longitudinal dynamic parameter may be upgraded to also require a second stage deployment based on significant lateral acceleration indicating an angle crash, without need for vector calculations of the monitored longitudinal dynamic parameter.

### BRIEF DESCRIPTION OF THE DRAWINGS

FIG. 1 is a schematic diagram of a vehicle having an occupant restraint system with a deployment control according to this invention.

FIGS. 2A and 2B show a computer flow chart partially illustrating the operation of the deployment control in the system of FIG. 1.

FIG. 3 shows plots of lateral acceleration and a boundary curve for comparison therewith as a function of event duration for several potential crash events.

FIG. 4 shows a computer flow chart partially illustrating the operation of the deployment control in the system of FIG. 1.

### DESCRIPTION OF THE PREFERRED EMBODIMENT

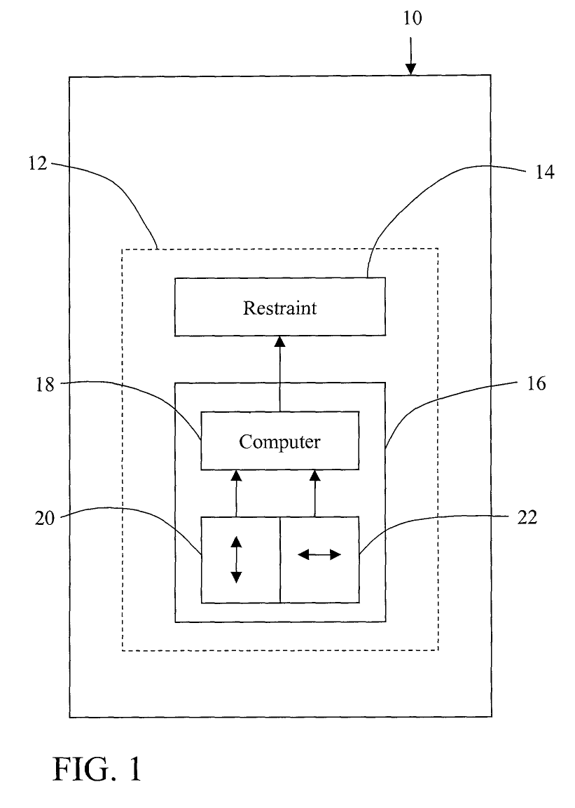

Referring to FIG. 1, a motor vehicle 10 has a passenger area or compartment 12 containing a deployable restraint apparatus 14 and a deployment control 16. Deployment control 16 includes a microcomputer 18, a longitudinal accelerometer 20 and a lateral accelerometer 22, each of the accelerometers providing an output signal to microcomputer 18, and microcomputer 18 provides a multiple stage deployment signal to restraint apparatus 14 which may initiate, for example, first stage deployment or second stage deployment. The multiple stage capability of the deployment signal controls restraint deployment to protect occupants in crashes of different severity by varying such restraint characteristics as the number of inflatable restraint devices deployed, the speed of their deployment, the pressure generated by the restraint, or any other characteristic(s) known in the art.

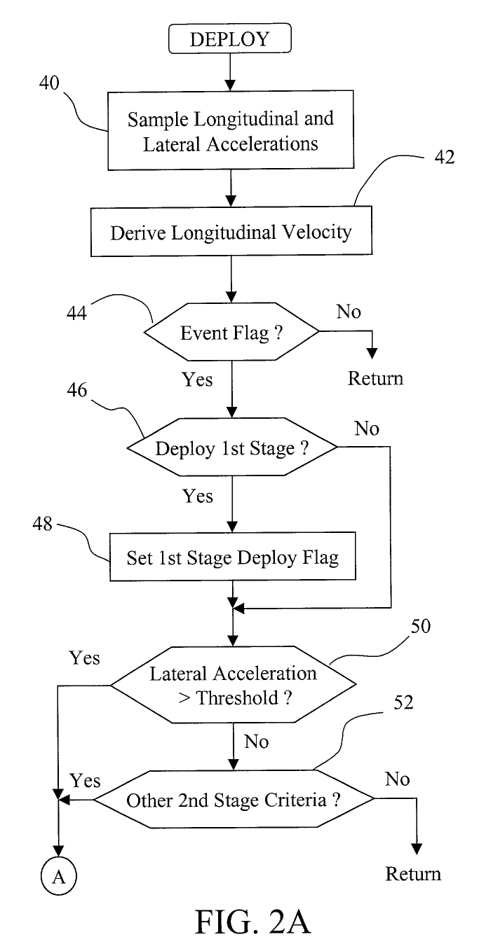

Microcomputer 18 is provided with a stored program for controlling deployment of restraint apparatus 14 in response to signals from accelerometers 20 and 22. This program is described with reference to the flow chart of FIG. 2. Program DEPLOY begins at step 40 by sampling the longitudinal and lateral acceleration signals from acceleration sensors 20 and 22, as well as any other vehicle parameters that might be required in a particular system. At step 42, the program derives the longitudinal velocity and whatever other parameters are required for the first stage and second stage deployment tests from the sensed parameters. The longitudinal velocity may be derived, for example, by digitally integrating the sensed longitudinal acceleration to provide a value use in a first stage deployment test. Parameters for the second stage test might include derived values for longitudinal jerk and oscillation as described in the aforementioned patent application U.S. Ser. No. 09/690,141 and/or U.S. Pat. No. 5,483,449. In addition, immunity measures such as an Event Progression Measure (EPM) or a Rough Road Measure (RRM), as described in the referenced application may be derived at this step. These second stage test and immunity measure parameters are optional with respect to this invention.

At step 44, program DEPLOY now determines whether an Event flag is set. The Event flag indicates that the system has determined that a possible crash event is in progress. The prior art is acquainted with many ways of accomplishing this; one particular method is testing the sensed acceleration value against a predetermined value somewhat higher than that produced in normal braking; e.g., about 2 g's. If program DEPLOY determines at step 44 that an EVENT flag is not set, then there is no possible crash event initiated; and the program skips the rest of the steps described herein. But if the EVENT flag is set, the program proceeds to step 46, wherein a group of tests are performed to determine if first stage deployment is required. These tests may include any tests known in the prior art for determining a first stage restraint deployment. An example combination is found in the above referenced patent application Ser. No. 09/690,141, with a primary comparison of the derived longitudinal velocity against a threshold value of a boundary threshold curve, the value varying along the boundary curve with time elapsed from the initiation of the crash event in the manner shown in the prior art. The immunity measure comparisons, if included, are also performed at this point so as to prevent undesired restraint deployment in special cases. If the tests indicate the desirability of first stage deployment, the 1st Stage Deploy flag is set at stage 48; if not, step 48 is skipped.

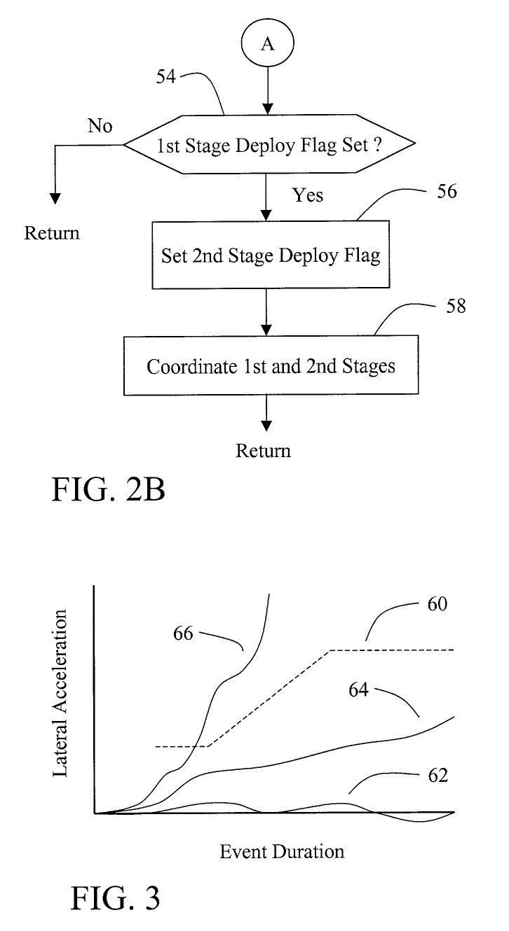

The program next determines if second stage deployment is required. This begins at step 50, wherein the sensed lateral acceleration exceeds a threshold value of a boundary curve. This process is illustrated by the chart of FIG. 3, wherein the vertical axis represents sensed lateral acceleration and the horizontal axis represents event duration, that is, the time elapsed since the initiation of a detected possible crash event. A possible second stage deployment will be indicated if the sensed lateral acceleration goes above dashed line 60, which represents the boundary curve for lateral acceleration as a function of event duration. Curve 62 represents a longitudinal crash event, with no lateral component, and thus essentially follows the horizontal axis. Curve 64 represents a low acceleration, low angle crash, in which sensed lateral acceleration does not exceed boundary curve 60 at any time during the event. Neither of these curves signal desirability of a second stage deployment. But curve 66, representing a high acceleration, angle crash, goes above boundary curve 60 early during the event. Thus, curve 66 would signal a possible second stage crash.

If a possible second stage crash event is not indicated at step 50, the program proceeds to step 52, wherein other, optional second stage criteria and/or immunity measures are tested, as an alternative test to that performed at step 50. Such second stage criteria are described in more detail in the above-referenced patent application and other prior art. If neither of steps 50 and 52 results in an indicated second stage crash event, the program returns without setting the 2nd Stage flag. But if either of the steps does indicate a second stage crash event, the program proceeds to determine, at step 54, if the 1st Stage flag is set. If it is not, the program returns without setting the 2nd Stage flag. But if it is, the 2nd Stage Deploy flag is set at step 56 before the program returns. Thus, a second stage deployment cannot occur unless a first stage deployment is also indicated.

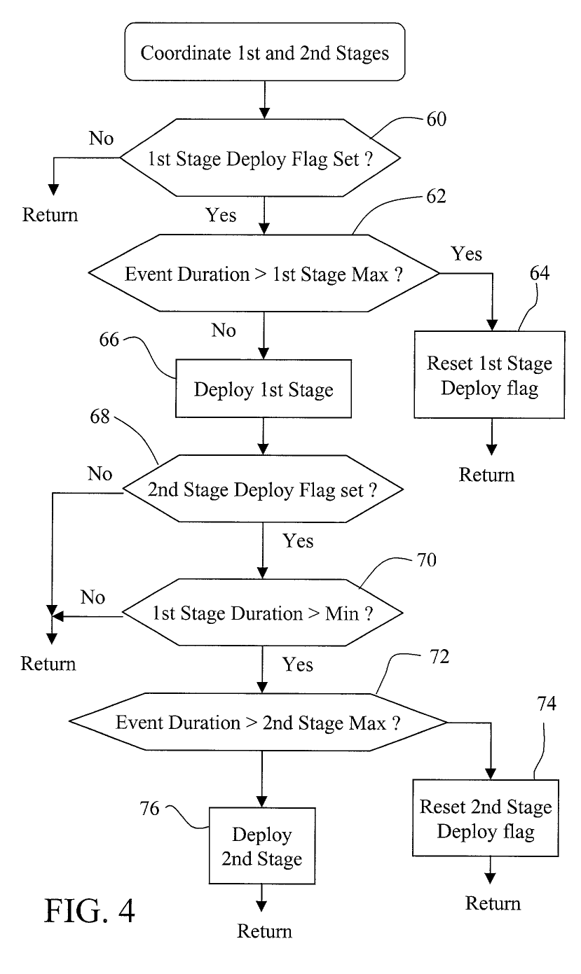

At step 58, the program coordinates the first and second stage deployment by running a subroutine shown in FIG. 4. At step 60, the 1st Stage Deploy flag is checked. If it is not set, the remainder of the subroutine is skipped. But if the 1st Stage Deploy flag is set, the subroutine proceeds to step 62, at which it is determined if the Event Duration has exceeded a Maximum value for first stage deployment. If it has, the 1st Stage Deploy flag is reset at step 64; and the subroutine is then exited. But if it has not, first stage deployment is initiated at step 66.

The subroutine then checks the 2nd Stage Deploy flag at step 68. If it is not set, the subroutine is exited; but if the 2nd Stage Deploy flag is set, the subroutine proceeds to step 70. At step 70, the subroutine determines if first stage deployment has existed for at least a minimum duration Min. After the initiation of first stage deployment in response to the setting of the 1st Stage Deploy flag, many types of restraint apparatus require a predetermined minimum time to elapse before second stage deployment may be initiated. An example of such a system is a single inflatable bag with separate first stage and second stage inflators. With such a system, the initiation of second stage deployment must be delayed for that predetermined period of time relative to the initiation of first stage deployment. Thus, from step 70, if the minimum time has not elapsed, the subroutine is exited. But if the minimum time has elapsed, the subroutine proceeds to step 72.

At step 72, the subroutine determines if the Event Duration has exceeded a second stage maximum duration. There is a time limit, measured from the beginning of the potential crash event, in which second stage deployment may be usefully initiated. Once that time limit is reached, no second stage deployment will be initiated, regardless of the 2nd Stage Deploy flag. Thus, from step 72, if the Event Duration exceeds 2nd Stage Max, the 2nd Stage Deploy flag is reset at step 74 and the subroutine exited. But if the 2nd Stage Max duration has not been exceeded, a second stage deployment is initiated at step 76 before the subroutine is exited.

1. A method for deploying a vehicle occupant restraint comprising the steps:
sensing a longitudinal acceleration of a vehicle passenger compartment;
processing the longitudinal acceleration to provide a first stage deployment function signal;
generating a first stage deployment signal based on a predetermined criterion of the first stage deployment function signal;
sensing a lateral acceleration of the vehicle passenger compartment;
generating a second stage deployment signal based on a predetermined criterion of the sensed lateral acceleration of the vehicle passenger compartment;
deploying the restraint in a first stage deployment dependent on the generation of the first stage deployment signal; and
deploying the restraint in a second stage deployment dependent at least on the generation of the second stage deployment signal.

2. The method of claim 1 wherein the first predetermined criterion comprises the first stage deployment function signal exceeding a first boundary curve and the second criterion comprises the sensed lateral acceleration exceeding a second boundary curve.

3. The method of claim 2 wherein the generation of the second stage deployment signal further requires generation of the first stage deployment signal.

4. The method of claim 2 wherein the first stage deployment function signal comprises a longitudinal velocity derived from the sensed longitudinal acceleration.

5. Vehicle occupant restraint apparatus comprising:
a first sensor indicating a longitudinal acceleration of a passenger compartment of the vehicle;
means responsive to the first sensor for generating a first stage deployment signal based on a predetermined criterion of the sensed longitudinal acceleration of the passenger compartment of the vehicle;
a second sensor indicating a lateral acceleration of the vehicle passenger compartment;
means responsive to the second sensor for generating a second stage deployment signal based on a predetermined criterion of the sensed lateral acceleration of the passenger compartment of the vehicle;
restraint deployment apparatus responsive to generation of the first stage deployment signal in a first stage deployment mode if the first stage deployment signal is generated and in a second stage deployment if the second stage deployment signal is generated.

6. The vehicle occupant restraint apparatus of claim 5 further comprising means for deriving a time integral of the sensed longitudinal acceleration of the passenger compartment of the vehicle and wherein the predetermined criterion of the sensed longitudinal acceleration of the passenger compartment of the vehicle comprises a predetermined value of the derived time integral of the sensed longitudinal acceleration of the passenger compartment of the vehicle.

7. The vehicle occupant restraint apparatus of claim 6 wherein the means responsive to the first sensor further comprise a memory storing a first boundary curve and means for deriving the time integral of the sensed longitudinal acceleration of the passenger compartment and repeatedly comparing the time integral to the first value curve and the means responsive to the second sensor comprise a second boundary curve.

8. The vehicle occupant restraint apparatus of claim 5 wherein generation of the second stage deployment signal further requires generation of the first stage deployment signal.
